(19) United States
(12) Patent Application Publication
(10) Pub. No.: US 2017/0053725 A1
(43) Pub. Date: Feb. 23, 2017

(54) Detachable Support Mount using Switchable Permanent Magnet

(71) Applicant: Lance James St. Onge, Culdesac, ID (US)

(72) Inventor: Lance James St. Onge, Culdesac, ID (US)

(21) Appl. No.: 15/242,314

(22) Filed: Aug. 19, 2016

Related U.S. Application Data
(60) Provisional application No. 62/207,894, filed on Aug. 20, 2015.

(51) Int. Cl. H01F 7/02; H01F 7/04; F16M 11/04; F16M 11/24; F16B 1/00; F16M 13/02

(52) U.S. Cl. CPC H01F 7/0242; F16B 1/00; F16M 13/02; F16M 11/041; F16M 11/242; H01F 7/04; F16B 2001/0035

(57) ABSTRACT

A Detachable Support Mount using Switchable Permanent Magnet

### CROSS-REFERENCE TO RELATED APPLICATIONS

This application claims priority to provisional application 62/207,894 filed on Aug. 20, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

Supports

Detachable support mounts have been used for many years in photography, bird watching, and shooting sports. Support mounts are frequently attached to devices by screwing a threaded male post into a threaded female nut in the device. This allows users to benefit from the portability of their devices by not having the often bulky support attached at all times. It also allowed users to attach a device to different supports at different times and attach different devices to a support at different times.

Although a threaded attachment can provide a very strong and secure attachment, that strength can come with the trade-off of taking a significant amount of time to attach and detach the device to and from the support. A threaded attachment may not consistently cause the attached device to point in the same direction and may not cause different devices to point in the same direction as each other. A threaded attachment is also subject to cross threading which can damage the support, the device, or both.

Various modifications to attachment mechanisms have been made to improve upon, alter, or enhance attachment characteristics. One common modification is a plate which attaches to the device and a plate adapter which attaches to the support where the plate and plate adapter are configured to mechanically connect and disconnect with each other.

Switchable Permanent Magnets

Switchable permanent magnets are well known in the art (see U.S. Pat. No. 6,707,360, herein incorporated by reference). Switchable permanent magnets can exert an attraction force in excess of 250 times the weight of the switchable permanent magnet. However, when switched, off, the attractive force can be reduced to nearly zero. There are a variety of ways of activating and deactivating a switchable permanent magnet. The inventor is aware of them and, though different activation mechanisms may offer different ergonomic advantages, each permits the advantages of the present invention.

### BRIEF SUMMARY OF THE INVENTION

The applicant's invention is a detachable support mount using a switchable permanent magnet to provide a strong attachment between the support and the attached device. The coupling surfaces of the support and attached device may have cooperatively coupling features to aid in centering and/or aligning. The support attachment may have physical extensions to assist in alignment.

### BRIEF DESCRIPTION OF THE SEVERAL VIEWS OF THE DRAWING

FIG. 1 shows the applicant's invention. Projecting from the right side is a switch controlling the switchable permanent magnet. In the top surface of the switchable permanent magnet support head, depression alignment features are shown. Above the head, a plate configured to couple with features in the support head is shown. Holes are also shown in the head configured for attaching a device to the plate. Shown below the support head are support legs.

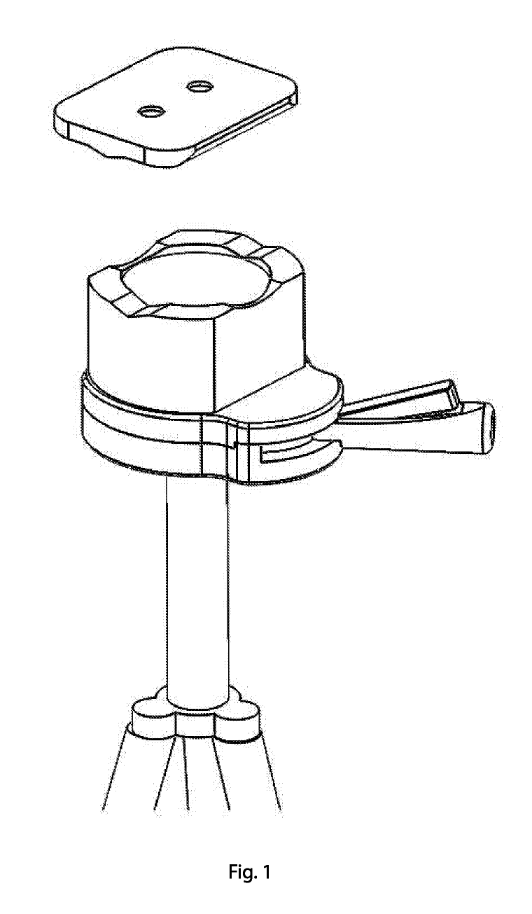

FIG. 2 shows the applicant's invention. On the right and left sides of the head are v-shaped alignment features. In the front and back of the head are rounded alignment features.

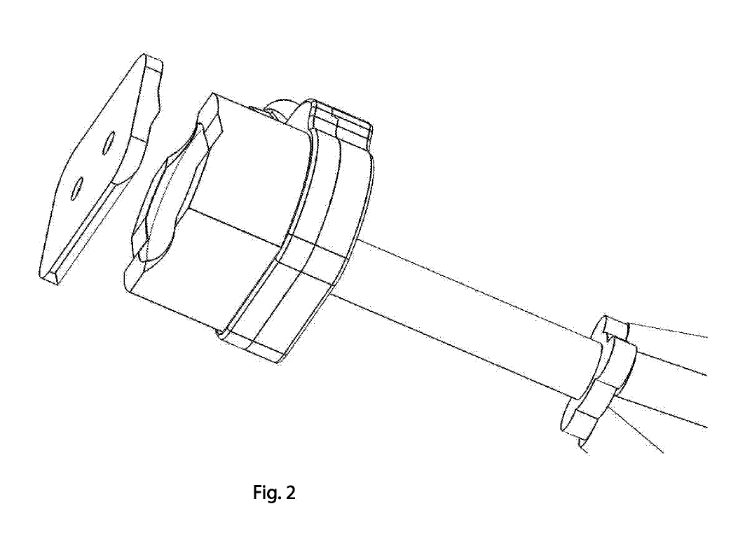

FIG. 3 shows the applicant's invention. On the underside of the plate v-shaped alignment features are shown. Recessed holes configured for attaching a device to the plate are also shown.

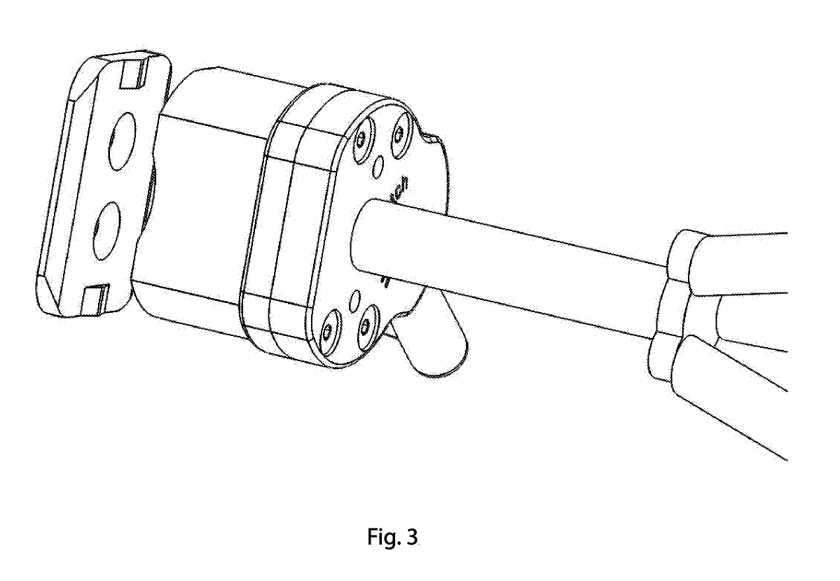

### DETAILED DESCRIPTION OF THE INVENTION

The present invention is an article of manufacture for attaching a device to a support using a switchable magnet. When the switchable permanent magnet is switched off, a device can be placed in proximity with the support with little or no attractive force exerted between the device and switchable permanent magnet. When the switchable permanent magnet is switched on, a great deal of attractive force is exerted on the device by the switchable permanent magnet in the support head preventing the device from rotating on, or disconnecting from, the support without the application of substantial force. In embodiments with one or more alignment features, alignment features designed to cooperatively couple facilitate detaching the device from the support and reattachment to the support such that the device is facing in the substantially similar direction. When the alignment features on multiple devices are directionally calibrated, one device can be can be detached from the support and another device attached to the support with the two devices facing in a substantially similar direction. This can be particularly useful in observation activities when optics with two different magnifications are used, one with lower magnification but a wider field of view to locate a subject of interest and another with greater magnification to provide greater detail. This can also be very useful in shooting sports where a spotting scope is used to locate the target, the support can be locked in position, then the spotting scope can be removed and a firearm placed on the support very nearly aimed at the target. A centering aid can be advantageous to help assure the device is reasonably well balanced on the support.

The connection between the device and support can be weakened, or severed entirely, by deactivating the switchable permanent magnet. When the device contains sufficient ferrous metal near the surface to be be attached to the support, the device may be directly attached to the switchable permanent magnet. When the device to be connected to the support does not contain sufficient ferrous metal near the surface to be attached, or lacks other desirable features, a ferrous attachment plate, optionally containing desirable features, may be attached to the device and the plate may be attached to the switchable permanent magnet. Desirable features may include, but are not limited to, centering and alignment features. In a preferred embodiment, there are no movable linkages between the plate and device minimizing opportunities for loss of calibration. In another embodiment, the head and plate are cooperatively configured to mechanically attach in addition to magnetically attach. Mechanical attachment provides additional protection against disconnection and resulting damage.

In an alternative embodiment, a force multiplying mechanical means for increasing the distance between the plate and the head is provided. The force multiplying mechanical means may include combinations of levers, gears, and other means of creating a mechanical advantage. This provides assistance in separating the head and plate in case the switch malfunctions or a non-switchable magnet is used.

The above non-limiting embodiments are exemplary. The foregoing embodiments represent preferred embodiments but other functional equivalents are known and anticipated by the applicant. Particularly, the reversal of features between the device and/or plate and base provides the benefits of the present invention without deviating from the invention.

1. An article of manufacture for attaching a device to a support using a switchable permanent magnet comprising:
a. a switchable permanent magnet support head, and
b. one or more alignment features on a surface of said switchable permanent magnet support head configured to aid in aligning an attached device.

2. The article of manufacture of claim 1 wherein the switchable permanent magnet support head is leg-supported.

3. The article of manufacture of claim 2 wherein the one or more alignment features are selected from the group of: depressions and protrusions.

4. The article of manufacture of claim 3 further comprising:
a. a plate having a surface configured to cooperatively couple with said one or more alignment features on a surface of the switchable magnet, and
b. said plate having a surface configured to securely attach to a device.

5. The article of manufacture of claim 4 wherein said plate is configured to attach to a device by means of a male threaded member configured to couple with a female threaded member configured in the device.

6. The article of manufacture of claim 4 wherein the one or more alignment features on a surface of the switchable magnet support head configured to aid in alignment limit the orientation of the device on the switchable magnet to a finite number of directions.

7. The article of manufacture of claim 6 wherein the one or more alignment features are comprised of a spherical cap and one or more radial features.

8. The article of manufacture of claim 6 wherein the one or more alignment features are comprised of v-shaped depressions.

9. The article of manufacture of claim 6 further comprising movable mechanical features which prevent said plate from being detached from said switchable magnet support head when engaged.

10. The article of manufacture of claim 6 further comprising a mechanical force multiplication means configured to aid in detaching said plate from said switchable permanent magnet support head.

11. The article of manufacture of claim 6 wherein said mechanical force multiplication means is a lever.

12. The article of manufacture of claim 6 wherein the switchable permanent magnet support head further comprises mechanical extensions which diverge as they extend away from said surface of the head.
